(19) United States
(12) Patent Application Publication
(10) Pub. No.: US 2009/0181130 A1
(43) Pub. Date: Jul. 16, 2009

(54) Food Gel Preparation Containing Fluid Dairy Product Inclusions

(75) Inventors: Olivier Noble, Orsay (FR); Flavien Lambert, Clamart (FR); Arnaud Lyothier, Asnieres Sur Seine (FR)

Correspondence Address: MORGAN LEWIS & BOCKIUS LLP, 1111 PENNSYLVANIA AVENUE NW, WASHINGTON, DC, 20004, US

(73) Assignee: Compagnie Gervais Danone, Paris (FR)

(21) Appl. No.: 12/299,111

(22) PCT Filed: Apr. 27, 2007
(86) PCT No.: PCT/FR2007/000727

§ 371 Date: Jan. 26, 2009

(30) Foreign Application Priority Data
May 3, 2006 (FR) 06/03930

(51) Int. Cl. A23C 9/137; A23L 1/05

(52) U.S. Cl. 426/89; 426/573

(57) ABSTRACT

The present invention relates to a method for preparing a food product constituted by a gel including fluid dairy product inclusions that take various forms, and to the food product obtained by said method. The invention also relates to the method for preparing a fluid dairy product with water activity (Aw) of between 0.89 and 0.91, and to said product obtained by said method.

The present invention relates to a method for preparing a food product constituted of a gel comprising fluid dairy product inclusions, and also to the food products that can be obtained by means of said method.

The coating of a food product, in particular of a fluid dairy product, in polymers for dietary use by means of dropping and/or coextrusion techniques is already known, for example through application WO 00/25597. Application WO 03/001919 also describes the preparation of a food product constituted of an animal meat base and/or of a dairy product base, coated with a material composed essentially of vegetable proteins and hydrocolloids, by means of a conventional coextrusion method.

However, these techniques do not make it possible to obtain fluid dairy product inclusions that take various forms. Due to the fluidity of the product to be coated, coated food products having shapes ranging from spherical (yoghurt beads) to elongated (sausage type) are typically obtained.

The inventors gave themselves the aim of preparing a food product constituted of a gel comprising fluid dairy product inclusions that take various forms.

The inventors have noted that it can be possible to obtain such inclusions by molding the fluid dairy product, by freezing it, by demolding it, and then by placing the frozen form thus obtained in a pregel and leaving it to thaw in situ.

However, a problem arises due to the exudation of liquid (phenomenon of syneresis) by the frozen form during the thawing in situ. This phenomenon causes the formation of pockets of serum, which is detrimental to the appearance of the dairy product and also to how the consumer perceives it in the mouth.

The inventors have noted that this syneresis phenomenon can be prevented by using a fluid dairy product, the water activity (Aw) of which is from 0.89 to 0.91. In order to obtain the desired Aw, said fluid dairy product should generally have a solids content of 65% to 75%, including from 10% to 12% of proteins, from 44% to 50% of carbohydrates and from 0.9% to 1.4% of minerals. These ranges may vary according to the quality of the carbohydrates and of the proteins used.

A subject of the present invention is thus a method for preparing a food product constituted of a gel comprising one or more fluid dairy product inclusion(s), said method comprising:
(a) preparing a pregel comprising at least one gelling agent in solution in water;
(b) preparing a fluid dairy product with a water activity (Aw) of between 0.89 and 0.91;
(c) molding, freezing, and then demolding the dairy product obtained in step (b);
(d) incorporating the dairy product obtained in step (c) into the pregel;
(e) gelling the product obtained in step (d).

Gelling agents that can be used for implementing the present invention are those conventionally used in the agro-food industry. By way of nonlimilting examples, mention may be made of gelling agents of gelatin, carrageenan, pectin, gellan gum or alginate type.

Gelling combinations of hydrocolloids, for example xanthan-carob or xanthan-konjac gum, may also be used. The solution of gelling agent(s) may also have sugar(s), flavoring(s), dye(s), extracts of fruit in the form of juice, puree or coulis, etc., added to it.

The concentration of gelling agent in the initial solution is not an essential feature of the present invention; it depends on the texture of the final product that it is desired to obtain, and can therefore be selected by those skilled in the art, according in particular to the gelling agent used, and, where appropriate, the other constituents present in the solution.

For the purpose of the present invention the term “pregel” is intended to mean a mixture comprising essentially one or more gelling agent(s) dissolved in water. This pregel instantaneously forms a layer of gel at the periphery of the frozen inclusion when the latter is deposited, thereby allowing correct positioning of the inclusion in the pregel.

To implement the present invention, a fluid dairy product which has a penetration resistance strength of between 200 and 300 grams, when the latter is measured using the TAXT2 penetrometer sold by Stable Micro Systems (Surrey, Great Britain), using a spindle consisting of a cylinder 0.5 inch in diameter, at 15 mm with a spindle descent at 0.2 mm/s, will preferably be used.

This encompasses especially fermented or nonfermented, semiliuid or pasty dairy products. By way of nonlimiting examples, mention will be made of stirred yoghurts and “fromage frails”.

Particularly advantageously, said fluid dairy product is a fermented dairy product.

However, the water activity (Aw) of the fluid dairy product, which is necessary for implementing the method defined above, is not compatible with bacterial development, and therefore with fermentation.

To solve this problem, the present invention provides a method for preparing a fermented dairy product with a water activity (Aw; between 0.89 and 0.91.

This method comprises the following steps:
(b1) preparing a fermented dairy product with a water activity (Aw) of 1, and a solids content of 28% to 38%, including from 7% to 10% of proteins and from 2% to 13% of fats; preferably with a solids content of 33% to 38%, including from 7.5% to 9.5% of proteins and from 6% to 13% of fats; and entirely preferably with a solids content of 35.5% to 37.5%, including from 8% to 9% of proteins and from 11% to 13% of fats; and a pH of less than or equal to 4.85;
(b2) preparing a combination of powders with a solids content of greater than or equal to 95%, and also an Aw-lowering capacity of greater than 1.05 sucrose equivalents and a sweetening capacity of 0.32 to 0.5 sucrose equivalent;
(b3) mixing a fermented dairy product obtained in step (b1) and a combination of powders obtained in step (b2), according to a ratio ranging from 40:60 to 55:45.

Advantageously, the fermented dairy product defined in step (b1) can be obtained by conventional fermentation up to a pH of 4.8 of a mixture comprising from 47% to 78% of skimmed milk, from 4.5% to 33% of cream containing 40% fat, from 5% to 10% of milk protein concentrate, from 10% to 15.5% of lactose, and 0.03% of yoghurt ferments; preferably of a mixture comprising from 49% to 60% of skimmed milk, from 15% to 33% of cream containing 40% fat, from 6% to 9% of milk protein concentrate, from 12% to 15% of lactose, and 0.03% of yoghurt ferments; and entirely preferably of a mixture comprising from 50% to 53% of skimmed milk, from 29% to 31% of cream containing 40% fat, from 7% to 8% of milk protein concentrate, from 13% to 14% of lactose, and 0.03% of yoghurt ferments.

Advantageously, the combination of powders defined in step (b2) contains from 32% to 38% of dehydrated glucose syrup, from 37% to 41% of yoghurt powders, including 4% to 6% of yoghurt powders at pH 4.3, from 18% to 22% of liquid glucose syrup, from 2% to 6% of amylose-containing icing sugar; more advantageously from 34% to 38% of dehydrated glucose syrup, from 38.5% to 39.5% of yoghurt powders, including 4% to 6% of yoghurt powders at pH 4.3, from 19.5% to 20.5% of liquid glucose syrup, from 3.5% to 4.5% of amylose-containing icing sugar; and entirely advantageously, 37% of dehydrated glucose syrup, 39% of yoghurt powders, including 4% to 6% of yoghurt powders at pH 4.3, 20% of liquid glucose syrup and 4% of amylose-containing icing sugar.

By way of nonlimiting examples, the yoghurt powder, the liquid glucose syrup and the dehydrated glucose syrup that can be used in the combination of powders, as defined above, may have an Aw-lowering capacity of, respectively, 1.2, 0.8 and 1.3.

A subject of the present invention is also a fermented dairy product with a water activity (Aw) of between 0.89 and 0.91, and a pH of less than or equal to 4.85, that can be obtained by means of the method defined above.

This fermented dairy product may be subsequently included in a gel, by implementing the inclusion method in accordance with the invention.

A subject of the present invention is also a food product constituted of a gel comprising one or more fluid dairy product inclusion(s), that can be obtained by means of an inclusion process in accordance with the invention.

The food products in accordance with the invention advantageously comprise from 30% to 60% (by weight) of fluid dairy product inclusions.

The food products in accordance with the invention may, for example, be in the form of transparent pots with a demoldable gel (100 to 150 g or from 20 to 50 g), or alternatively mouthfuls obtained by setting of the gel in a mold and demolding before packaging (10 to 25 g) in a rigid packaging which preserves their integrity.

They may be conserved in positive-cold storage for 4 to 6 weeks, without showing any phenomenon of syneresis, deformation of the inclusions, or degradation of the gel. After 28 days, they generally contain approximately 10⁴ CFU/g of live Lactobacillus bulgaricus and more than 10⁸ CFU/g of live Streptococcus thermophilus.

The present invention will now be described with the aid of the exemplary embodiments which follow, which are given by way of illustration and which are not limiting.

### EXAMPLE 1

### Preparation of a Fermented Dairy Product with a Reduced Water Activity

### Preparation of a Yoghurt

### Yoghurt Recipe:

| | |
|---|---|
| Skimmed milk | 51 to 51.5% |
| Cream containing 40% fat | 29 to 31% |
| Milk protein concentrate NZMP4861 | 7 to 8% |
| (Fronterra) | |
| Lactose | 11 to 12% |
| Lactic ferments [for example of | 0.03% |
| 542 011 ferments type (CHR Hansen)] | |

The formulation is rehydrated at 40° C. in order to thoroughly dissolve the lactose.

### Method of Yoghurt Production:

1— pasteurization at 95° C. for 6 minutes, and homogenization at 200 bar;
2— fermentation until a pH of 4.8 is obtained;
3— smoothing using an IKA® Labor-Pilot 2000/4 dynamics smoothing mixer (Werke GmbH & Co. KG) consisting of one stage with 3 rings at 4000 rpm, in order to obtain a smooth, grainless and shiny texture;
4— cooling to 4° C.

The yoghurt thus obtained has the following characteristics: 36.5% solids, 12% fat and 8.41 proteins.

### Preparation of a Combination of Powders

A premix of the following powders is prepared:

| Ingredient | Origin | % |
|---|---|---|
| Dehydrated glucose syrup | Cerestar | 34 |
| C*Sperse01934 | | |
| Yoghurt powder M/A 5.4 | Dr. Suwelack | 29 |
| Liquid glucose syrup | Cerestar | 20 |
| C*SweetM01656 | | |
| Yoghurt powder A 4.3 | Dr. Suwelack | 10 |
| Amylose-containing icing sugar | Any | 6.5 |
| Yoghurt flavoring 630455H | Givaudan | 0.5 |

### Preparation of the Fermented Dairy Product Ready to Include in the Gel

A 50/50 mixture of yoghurt and of the combination of powders is prepared with a planetary beater, at maximum speed, for 20 minutes, under cold conditions.

The dairy product obtained has a water activity (Aw) of 0.9±0.01 measured with an AquaLab® Aw-meter (Decagon Devices, Inc.), and a pH of 4.8±0.05; it comprises, per 100 g: 10.9 g of proteins, 6.2 g of fat, 47.6 g of carbohydrates and 327 mg of calcium, and has an energy value of 290 kCal/100 g. It contains >10⁸ live ferments.

### Molding and Freezing of the Fermented Dairy Product

The fermented dairy product obtained is dispensed into molds, and then frozen at −18° C.

### EXAMPLE 2

### Preparation of a Food Product Constituted of a Gel Comprising Fermented Dairy Product Inclusions

### Production of a Pregel

Three gel composition examples are given in the tables below.

### Flavored Sweet Gel:

| | |
|---|---|
| Genutine type 400-C (E407 | 1-1.2% |
| carrageenans, supplied by CP Kelco) | |
| Sugar | 18% |
| Water (demineralized) | 80-80.2% |
| Citric acid | 0.2% |
| Potassium citrate | 0.3% |
| Calcium chloride•2H₂O | 0.15% |
| Dye | 0.085% |
| Flavoring | 0.03% |

Gel with Fruit Coulis:

| | |
|---|---|
| Genutine type 400-C (E407 | 1-1.2% |
| carrageenans, supplied by CP Kelco) | |
| Sugar | 10% |
| Water (demineralized) | 48.5-48.3% |
| Potassium citrate | 0.3% |
| Calcium chloride•2H₂O | 0.18% |
| Raspberry coulis | 40% |

Gel with Fruit Juice:

| | |
|---|---|
| Genutine type 400-C (E407 | 0.7-1.2% |
| carrageenans, supplied by CP Kelco) | |
| Sugar | 10% |
| Water (demineralized} | 73.2-78.7% |
| Potassium citrate | 0.3% |
| Calcium chloride•2HaO | 0.12% |
| Flavoring | 0.15% |
| Concentrated fruit (peach) juice | 10-15% |
| (*6.5) | |
| Beta-carotene dye | 0.05% |
| Ascorbic acid | 0.01% |

For the preparation of the pregel, the components are mixed under cold conditions. The composition is gradually brought (for approximately 10 min) to 90° C., is heated at 90° C. for 30 seconds, and is then cooled to 60° C. with stirring at ambient temperature.

### Inclusion of the Fermented Dairy Product

The pregel obtained as described above is transferred into a cold mold before gelling.

The frozen fermented dairy product obtained as described in example 1 is demolded, and the inclusions thus obtained are deposited in the pregel at 60° C. and sink into the latter.

The heat exchanges at 4° C. between the frozen inclusions and the pregel at 60° C. allow the instantaneous formation of a layer of gel at the periphery of the dairy inclusions when they are deposited (thus allowing correct positioning of the inclusions in the pregel) and in situ thawing of said inclusions.

The final product is stored under positive-cold (4° C.) conditions.

### Packaging of the Final Product:

The final product constituted of a gel comprising fermented dairy product inclusions can be packaged in two forms:
transparent pots with a demoldable gel: the final product is in its packaging container (100 to 150 g), in which the setting of the gel and the inclusions were carried out.
Mouthfuls: the final product is in the form of mouthfuls obtained by setting of the gel in a mold, and then demolding before packaging (10 to 25 g) in a rigid container which preserves their integrity.

1. A method for preparing a food product constituted of a gel comprising one or more fluid dairy product inclusion(s) that take(s) various forms, said method comprising:
(a) preparing a pregel comprising at least one gelling agent in solution in water;
(b) preparing a fluid dairy product with a water activity (Aw) of between 0.89 and 0.91;
(c) molding, freezing, and then demolding the dairy product obtained in step (b);
(d) incorporating the dairy product obtained in step (c) into the pregel;
(e) gelling the product obtained in step (d).

2. A method for preparing a fluid dairy product as defined in step (b) of the method as claimed in claim 1, wherein said product is a fermented dairy product, and wherein said method comprises:
(b1) preparing a fermented dairy product with a water activity (Aw) of 1, and a solids content of 28% to 38%, including from 7% to 10% of proteins, from 2% to 13% of fats; and a pH of less than or equal to 4.85;
(b2) preparing a combination of powders with a solids content of greater than or equal to 95%, and also an Aw-lowering capacity of greater than 1.05 sucrose equivalents and a sweetening capacity of 0.32 to 0.5 sucrose equivalent;
(b3) mixing a fermented dairy product obtained in step (b1) and a combination of powders obtained in step (b2), according to a ratio ranging from 40:60 to 55:45.

3. The method as claimed in claim 2, wherein step (b1) is carried out by fermentation up to a pH of 4.8 of a mixture comprising from 47% to 78% of skimmed milk, from 4.5% to 33% of cream containing 40% fat, from 5% to 10% of milk protein concentrate, from 10% to 15.5% of lactose, and 0.03% of yoghurt ferments.

4. The method as claimed in claim 2, wherein the combination of powders defined in step (b2) contains from 32% to 38% of dehydrated glucose syrup, from 37% to 41% of yoghurt powders, including 4% to 6% of yoghurt powders at pH 4.3, from 18% to 22% of liquid glucose syrup, and from 2% to 6% of amylose-containing icing sugar.

5. A fermented dairy product with a water activity (Aw) of between 0.89 and 0.91, and a pH of less than or equal to 4.85, that is obtained by the method as claimed in claim 2.

6. The method as claimed in claim 1, wherein step (b) is carried out by implementing the method as claimed in claim 2.

7. A food product that is obtained by the method as claimed in claim 1.

8. The food product as claimed in claim 7, wherein the product comprises from 30% to 60% of dairy product inclusions.

9. A food product that is obtained by the method as claimed in claim 6.

10. The food product as claimed in claim 9, wherein the product comprises from 30% to 60% of dairy product inclusions.

11. A fermented dairy product with a water activity (Aw) of between 0.89 and 0.91, and a pH of less than or equal to 4.85, that is obtained by the method as claimed in claim 3.

12. The method as claimed in claim 1, wherein step (b) is carried out by implementing the method as claimed in claim 3.

13. A fermented dairy product with a water activity (Aw) of between 0.89 and 0.91, and a pH of less than or equal to 4.85, that is obtained by the method as claimed in claim 4.

14. The method as claimed in claim 1 wherein step (b) is carried out by implementing the method as claimed in claim 4.
